(19) United States
(12) Patent Application Publication
(10) Pub. No.: US 2006/0000374 A1
(43) Pub. Date: Jan. 5, 2006

(54) Hand stamp comprising interchangeable stamp plates and stamp plates for a hand stamp

(76) Inventor: Ernst Faber, Wels (AT)

Correspondence Address: WILLIAM COLLARD;COLLARD & ROE, P.C., 1077 NORTHERN BOULEVARD, ROSLYN, NY, 11576, US

(21) Appl. No.: 10/530,148

(22) PCT Filed: Sep. 10, 2003
(86) PCT No.: PCT/AT03/00269

§ 371 Date: Apr. 1, 2005

(30) Foreign Application Priority Data
Oct. 4, 2002 (AT) GM 6622002

(51) Int. Cl. B41K 1/42; B41K 1/38

(52) U.S. Cl. 101/334; 101/327

(57) ABSTRACT

The invention relates to a hand stamp (1) comprising a stamp plate carrier (2) and a stamp plate (3), in addition to engagement parts that are provided on said stamp plate carrier (2) and stamp plate (3) and that enable the carrier and plate to be removably connected. The engagement parts are configured from multiple channels and webs (4, 5). The hand stamp (1) can be configured as a self-inking stamp with a reversing mechanism.

The invention relates to a hand stamp, preferably a self-inking stamp with a turning mechanism, with a stamp plate carrier and a stamp plate as well as with engaging parts on the stamp plate carrier and on the stamp plate for a releasable interconnection thereof.

Furthermore, the invention relates to a stamp plate for a hand stamp, with engaging parts for a releasable interconnection with a stamp plate carrier of the hand stamp.

From AT 1240 U1, and from the corresponding U.S. Pat. No. 5,209,886 A, a hand stamp is known, in which a plug-in connection is provided between a stamp plate and a stamp plate carrier with the help of a plug-in projection engaging in a recess. However, this plug-in connection has the drawback that the stamp plate is relatively loosely mounted on the stamp plate carrier; therefore, there is the risk that the stamp plate will unintentionally become detached from the carrier, or, at least, will inadvertently be rotated relative to the carrier so that the stamp imprint will not be produced in the desired orientation.

WO 02/058937 A1 describes a self-inking hand stamp comprising a pivotable character unit carrying both stationary as well as exchangeable stamp characters. The exchangeable stamp characters are insertable in recesses in the character unit via plug-in projections, whereas the stationary stamp characters are arranged on a stamp plate on the character unit. The stamp plate of this hand stamp is fixedly attached on the stamp plate carrier so that the stamp imprint produced therewith cannot be varied. It is also disadvantageous that the exchangeable stamp characters are seated in a window-like opening, thus requiring an insertion tool for ex-changing the exchangeable stamp characters.

DE 198 26 762 A1 discloses a stamp for printing a motif on a surface, in particular on human skin, wherein a motif body with a printing surface carrying the negative of the motif is held on the base body of the stamp via a magnetic connection. For this, a permanent magnet must be arranged on the base body which, moreover, is provided with recesses for positioning into which the projections of the magnetic motif body engage.

From U.S. Pat. No. 2,143,833 A a stamp is known in which a stamp plate is fastened via a dove-tail connection to a stamp plate carrier formed in one piece with a handle, for which purpose the stamp plate is inserted into a dove-tail-shaped recess of the stamp plate carrier. However, in complex stamp designs like those comprising a turning mechanism, such a type of connection is practically impossible.

Therefore, it is an object of the invention to provide a hand stamp and a stamp plate, respectively, as initially defined, in which a releasable connection between the stamp plate and the stamp plate carrier is simple to realize, yet reliable, so that the stamp plate nevertheless can be connected to the stamp plate carrier in a stable, durable manner and fixed against rotation.

In a hand stamp of the initially defined kind, this object is achieved according to the invention in that the engaging parts are formed by multiple groove/web structures. Such a design ensures a safe fit of the stamp plate on the stamp plate carrier (carrier in short hereinafter), wherein the entire contact surfaces (for a press or snap fit) between the two parts are enlarged in a simple manner. Putting the stamp plate on the carrier is just as easy to do as is an intentional release of the stamp plate from the carrier which, in case of a rubber stamp plate, can be effected in the manner of a “peeling off”.

Thus, it is a basic idea of the invention to design the mutually complementary engaging parts of the stamp plate and of the carrier, respectively, such that they yield a relatively large overall contact or contacting surface. This is realized by the inventive groove/web structures. The stamp plate can be connected to the carrier in a snap fit, i.e. by positive engagement, or in a narrow snug fit, i.e. by non-positive engagement.

The relatively large overall contact surface also yields the further advantage of the releasable stamp plate that the latter can be exchanged easily for another stamp plate. When attaching a (different) stamp plate on the carrier, the webs and grooves can surprisingly be plugged into each other without any problems if simply care is taken that the grooves/webs of the stamp plate/carrier extend in parallel to each other, or that the rims of the stamp plate and of the carrier are in alignment.

As regards a simple, cost-efficient production and an attachment of the stamp plate without any problems, it is advantageous if the grooves and the webs have a rectangular, in particular square, cross-section. As an alternative, the grooves and the webs may have cross-sections engaging one behind the other. This can be realized, e.g., by a trapezoidal, rhomboidal or the like cross-section. Of course, it can also be envisaged to provide other undercut shapes, e.g. with a dove-tail-shaped cross-section or with curved side faces.

A particularly good, tight fit of the stamp plate on the carrier is attained if the groove/web structures are provided substantially on the entire surface of the carrier or of the stamp plate, respectively. In such an instance it is, e.g., suitable to provide a rim-side recess on the stamp plate which may extend over the entire rim or which may also be provided only at certain sites thereof. Such a recess is suitable with a view to receiving a corresponding peripheral projection of the stamp carrier.

For reasons of a simple and cost-efficient production of the stamp plate and of the carrier, respectively, it is advantageous when the groove/web structures have grooves parallel to each other and webs correspondingly parallel to each other.

In this connection, it is also suitable if the grooves and webs are equally wide.

Furthermore, it is suitable if the grooves and webs each have the same height or depth. Yet it is, of course, also possible to provide varying depths of the grooves or heights of the webs so as to control the fit of the stamp plate on the carrier—optionally in certain areas thereof.

A preferred feature of the invention also consists in providing transverse grooves which traverse the grooves, and corresponding transverse webs. This provides an additional fixation and facilitates the alignment of the stamp plate.

For a releasable connection of stamp plate and carrier via grooves or webs, utilizing a snug fit or a friction fit, it is particularly advantageous if the carrier is made of a dimensionally stable material. This ensures a simple attachment of the stamp plate on the carrier, since the carrier is not bendable. As such, the carrier may be produced of metal, preferably, however, it is made of plastics, advantageously of rigid plastics, such as, e.g., ABS plastics.

Attaching and detaching or exchanging the stamp plate will be particularly easy if the stamp plate is made of an elastic material, preferably of caoutchouc. Advantageously, this will be a soft-elastic rubber material, such as, e.g., NR-based caoutchouc (natural caoutchouc or isoprene caoutchouc), and/or butadiene acrylonitrile caoutchouc. If the stamp plate is made of a soft or bendable material as compared to the material of the carrier, particularly advantageously a frictional or snug fit can be provided.

A further preferred feature of the invention consists in providing receiving means for letters or stamp characters on that side of the stamp plate which faces away from the groove/web structures. Advantageously, these receiving means again are provided in the form of grooves, wherein, in particular, a parallel arrangement of the grooves may be realized.

For an improved connection, safely preventing an undesired detachment of letters or stamp characters, as well as ensuring a good fit of the same on the stamp plate, it is suitable if the receiving means have rounded or chamfered undercuts. For the sake of simplicity, the receiving means may, of course, also have a simple rectangular or square cross-section, as long as a sufficient press fit is ensured.

For exchanging the letters so as to obtain individual, adaptably designed stamp imprints, it is particularly advantageous if the letters are made of an elastic material, preferably of plastics or caoutchouc. Even if the stamp plate is produced of an elastic material, the letters may be made of a similar or of the same material.

For a frequent use of the stamp plate it is particularly advantageous if several letters or stamp characters are interconnected. In this case, pre-fabricated words or combinations of words, signs, special signs, whole syllables or also multi-digit numbers etc. may be provided in one piece.

From the foregoing it results that the subject matter of the invention is a hand stamp, as indicated, and also a stamp plate as such, as indicated, which subsequently is combined with a hand stamp—that does not yet have a stamp plate, but does have an appropriate carrier. The hand stamp may advantageously be designed as a self-inking stamp comprising a turning mechanism.

In the following, the invention will be explained in more detail by way of preferred exemplary embodiments illustrated in the drawings, to which, however, it shall not be restricted. In detail, in the drawings

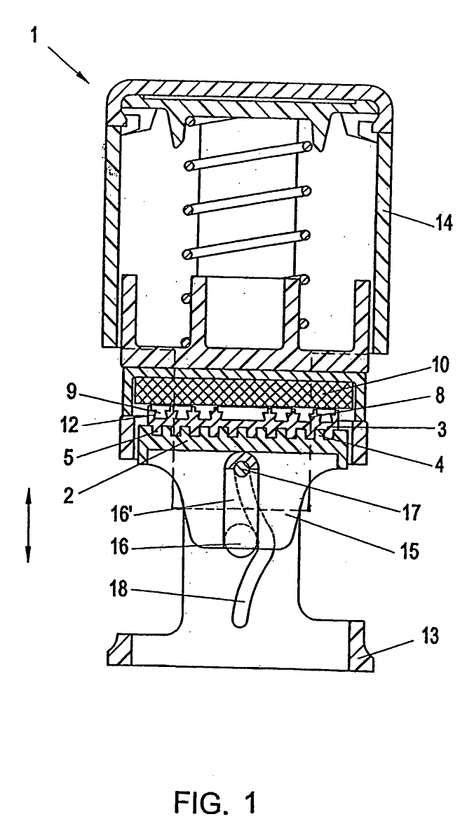

FIG. 1 shows a schematic, sectional view of a hand stamp comprising a self-inking device and a turning mechanism;

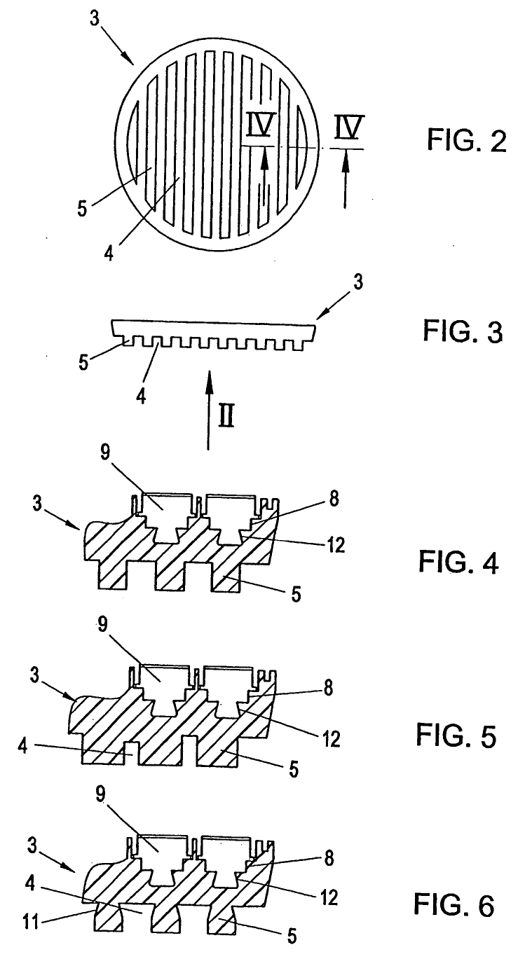

FIG. 2 shows a stamp plate according to the invention in a top view;

FIG. 3 shows a stamp plate according to FIG. 2 in side view;

FIGS. 4, 5 and 6 show detailed sectional views of various embodiments of the stamp plate according to line IV-IV in FIG. 2, with additional exchangeable letters or stamp characters; and

FIGS. 7 and 8 show further exemplary embodiments of the stamp plate seen in top view.

In FIG. 1, partly schematically, a hand stamp 1 of generally circular cross-section is illustrated approximately true to size in a longitudinal section, which in a per se conventional manner therefore not requiring any further explanation is equipped with a self-inking device, with a turning mechanism (e.g. of the type described in U.S. Pat. No. 4,432,281 A or in AT 384,999 B). The hand stamp 1 is shown in its resting position, in which a stamp plate 3 mounted on a stamp plate carrier 2 contacts an ink pad 10, i.e. the stamp plate 3 is on top. The stamp 1 furthermore contains a housing 13 and an actuating yoke with a handle 14. The carrier 2 has downwardly projecting guiding legs 15, on which one laterally projecting axle 17 each is attached; the axles 17 engage in guiding slots 18 which are provided in the housing 13 of the hand stamp 1, and further project into recesses not further illustrated of yoke projections of the yoke 14. The turning axle of the turning mechanism is further also realized in per se conventional manner by pins 16 on the inner side of the housing 13, which pins engage in guiding slots or grooves 16′ of the legs 15 of the carrier 2.

The stamp plate 3 is connected to the carrier 2 via engaging parts having the form of multiple groove/web structures 4, 5. Furthermore, releasable letters or stamp characters 9 inserted in the stamp plate 3 are shown, wherein character-receiving means 8 are provided on the side of the stamp plate 3 which faces away from the carrier 2. These characters 9 directly contact the ink pad 10.

FIGS. 2, 7 and 8 show embodiments of the stamp plate 3, wherein the side facing the carrier 2 (not illustrated) is shown in a top view. In FIG. 2, the grooves 4 and the webs 5 are all parallel to each other, the grooves 4 and the webs 5 all being equally wide. Furthermore, it can be seen from FIG. 2 and also from FIG. 3 that the grooves 4 and the webs 5 are arranged on the entire surface of the stamp plate 3, and only on the rim-side a recess is provided so as to make room for a corresponding peripheral projection of the carrier 2 (see FIG. 1). Besides, the carrier 2 has complementary grooves and webs.

Further embodiments of the stamp plate are illustrated in FIGS. 7 and 8, the stamp plate 3 according to FIG. 7 having grooves 4 and webs 5 in concentric arrangement. In FIG. 8, a stamp plate 3 similar to that of FIG. 2 is shown, wherein additional transverse grooves or transverse webs 7 are provided, thereby creating a kind of net pattern.

The stamp plate 3 need not necessarily be circular by design, it may also have other shapes, such as rectangular, square shapes or the like.

To make a connection between stamp plate 3 and carrier 2, they are pressed to one another, wherein the respective webs 5 on one part 3 or 2 are pressed into the grooves of the other part 2 or 3. The grooves and web structures on the carrier 2 and on the stamp plate 3 are thus complementary to each other.

FIG. 4 shows a schematic cross-section of the stamp plate 3 according to FIG. 2 (section IV) on an enlarged scale, the lower side illustrated in FIG. 3 (see arrow II in FIG. 3) of the stamp plate 3 being that side with which the stamp plate 3 is attached on the carrier 2 in a positive engagement or in snug fit. According to FIG. 4, the grooves 4 and webs 5—as in FIG. 3—have rectangular cross-sections. The grooves 4 and webs 5 are equally wide, wherein a symmetric arrangement with respect to an axial middle plane has also been realized so as to allow the stamp plate 3 to be fixed on the carrier 2 in two possible orientations.

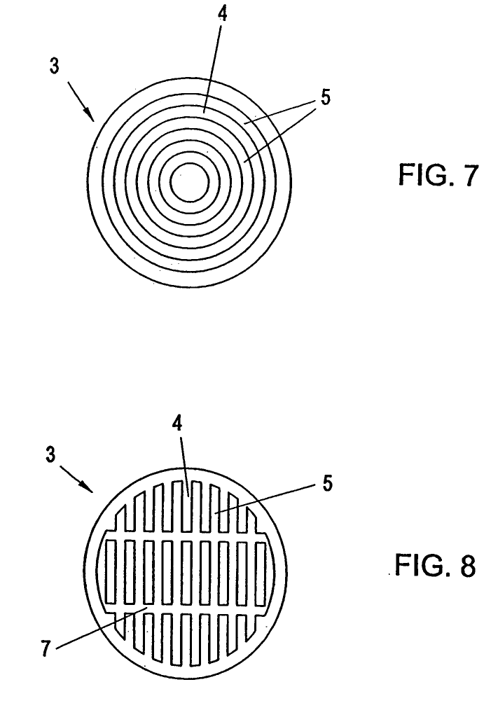

In addition, in the embodiment illustrated in FIG. 4—similar to FIGS. 5 and 6—releasable letters or stamp characters 9 can be seen on the side of the stamp plate 3 opposite the grooves 4 and webs 5. These stamp characters 9 are tightly, but releasably, seated in receiving means 8, the receiving means 8 having undercuts 12 of, e.g., dove-tail shaped cross-section so as to provide a secure fit of the stamp characters 9.

According to FIG. 5, grooves 4 and webs 5 of varying widths and varying heights are provided on the lower side of the stamp plate 3 (and, correspondingly, on upper side of the carrier 2, not illustrated).

Finally, in FIG. 6 widening webs 5 or undercut grooves 4—e.g. of dove-tail-shaped cross-section—are illustrated, the upper side of the carrier 2 (not shown in FIG. 6) of course again being of complementary design.

1. A hand stamp (1) with a stamp plate carrier (2) and a stamp plate (3) as well as with engaging parts on the stamp plate carrier (2) and on the stamp plate (3) for a releasable interconnection thereof, wherein the engaging parts are formed by multiple groove/web structures (4, 5).

2. A hand stamp according to claim 1, wherein the groove/web structures (4, 5) have rectangular cross-sections.

3. A hand stamp according to claim 2, wherein the groove/web structures (4, 5) have square cross-sections.

4. A hand stamp according to claim 1, wherein the grooves (4) and the webs (5) have cross-sections engaging one behind the other.

5. A hand stamp according to claim 4, wherein the grooves (4) and the webs (5) have trapezoidal cross-sections.

6. A hand stamp according to claim 1, wherein the groove/web structures (4, 5) are arranged on the entire surface of the carrier (2) or of the stamp plate (3), respectively.

7. A hand stamp according to claim 1, wherein the groove/web structures (4, 5) have grooves (4) parallel to each other and webs (5) correspondingly parallel to each other.

8. A hand stamp according to claim 7, wherein the grooves (4) and webs (5) are equally wide.

9. A hand stamp according to claim 7, wherein the grooves (4) and webs (5) are equally high.

10. A hand stamp according to claim 1, wherein transverse grooves traversing the grooves (4) and corresponding transverse webs (7) are provided.

11. A hand stamp according to claim 1, wherein the carrier (2) is made of a dimensionally stable material.

12. A hand stamp according to claim 11, wherein the carrier (2) is made of plastics.

13. A hand stamp according to claim 1, wherein the stamp plate (3) is made of an elastic material.

14. A hand stamp according to claim 13, wherein the stamp plate (3) is made of caoutchouc.

15. A hand stamp according to claim 1, wherein receiving means (8) for letters, or stamp characters (9), respectively, are formed on the side of the stamp plate (3) that faces away from the groove/web structures (4, 5).

16. A hand stamp according to claim 15, wherein the letters/stamp characters (9) are made of an elastic material.

17. A hand stamp according to claim 16, wherein the letters/stamp characters (9) consist of a material selected from the group consisting of plastics or caoutchouc.

18. A hand stamp according to claim 15, wherein several letters/stamp characters (9) are interconnected.

19. A hand stamp according to claim 15, wherein the receiving means (8) have rounded undercuts (12).

20. A hand stamp according to claim 1, characterized by a design as a self-inking stamp with a turning mechanism.

21. A stamp plate for a hand stamp with engaging parts for a releasable interconnection with a stamp plate carrier of the hand stamp, wherein the engaging parts are formed by a multiple groove/web structure (4, 5).

22. A stamp plate according to claim 21, wherein the grooves (4)/webs (5) have rectangular cross-sections.

23. A stamp plate according to claim 22, wherein the grooves (4)/webs (5) have square cross-sections.

24. A stamp plate according to claim 21, wherein the grooves (4) and the webs (5) have cross-sections engaging one behind the other.

25. A stamp plate according to claim 24, wherein the grooves (4) and the webs (5) have trapezoidal cross-sections.

26. A stamp plate according to claim 21, wherein the groove/web structures (4, 5) are arranged on the entire surface of the stamp plate (3).

27. A stamp plate according to claim 21, wherein parallel grooves and webs (5) are provided.

28. A stamp plate according to claim 21, wherein the grooves (4) and webs (5) are equally wide.

29. A stamp plate according to claim 21, wherein the grooves (4) and webs (5) are equally high.

30. A stamp plate according to claim 21, wherein transverse grooves (7) traversing the grooves (4) and corresponding transverse webs are provided.

31. A stamp plate according to claim 21, wherein it comprises a plate body of elastic material.

32. A stamp plate according to claim 31, wherein the plate body consists of caoutchouc.

33. A stamp plate according to claim 21, wherein receiving means (8) for letters/stamp characters (9) are formed on the side which faces away from the groove/web structure (4, 5).

34. A stamp plate according to claim 32, wherein the receiving means (8) have rounded undercuts (12).
